(19) United States
(12) Patent Application Publication
(10) Pub. No.: US 2026/0114474 A1
(43) Pub. Date: Apr. 30, 2026

(54) METHODS AND SYSTEMS FOR IMPROVING BIOAVAILABILITY IN FOODS AND FEEDS

(71) Applicant: Prototype Garage, LLC, Little Canada, MN (US)

(72) Inventor: Olaf LEE, Forest Lake, MN (US)

(21) Appl. No.: 19/471,206

(22) PCT Filed: Apr. 4, 2024
(86) PCT No.: PCT/US2024/023103

§ 371 Date: Sep. 30, 2025

Related U.S. Application Data
(60) Provisional application No. 63/456,983, filed on Apr. 4, 2023.

(51) Int. Cl. A23K 10/30; A23K 40/00; A23K 50/10; A23N 17/00

(52) U.S. Cl. CPC A23K 10/30; A23K 40/00; A23K 50/10; A23N 17/004; A23N 17/007

(57) ABSTRACT

The patent application describes a method of increasing bioavailability of animal feed comprising: hydrating a starting animal feed material with water to provide a hydrated animal feed material containing from 50 wt % to 99.99 wt % H₂O; in a continuous-flow processing chamber, treating the hydrated animal feed material at a processing temperature selected from 40° C. to 90° C., a processing pressure (vacuum) selected from −5 psig to −14 psig, and a processing residence time selected from 1 minute to 60 minutes, thereby generating a processed animal feed material; and recovering the processed animal feed material as an enhanced-bioavailability animal feed. The enhanced-bioavailability animal feed has higher bioavailability compared to the starting animal feed material. Systems for increasing bioavailability of animal feed are also described and shown in drawings. Experimental examples are included, demonstrating significant enhancement of bioavailability using the disclosed technology, as measured by neutral detergent fiber digestibility at 12 hours.

### PRIORITY DATA

This patent application is an international Patent Cooperation Treaty patent application with priority to U.S. Provisional Patent App. No. 63/456,983, filed on Apr. 4, 2023, which is hereby incorporated by reference herein.

### FIELD OF THE INVENTION

The present invention generally relates to methods and systems for treating feed materials to enhance their bioavailability for animals, and bioavailable products produced from these methods and systems.

### BACKGROUND OF THE INVENTION

Accessing more energy from existing feeds and foods is a goal of many feed and food companies. Higher energy access reduces costs and improves growth in many ways, which could have far-reaching impacts across the globe.

If a farmer can increase bioavailability of a given weight of feed, less overall weight is required, reducing financial costs as well as environmental costs—e.g., less manure and less methane created.

It is especially desired to overcome low throughput and recovery rates, and to improve loading and unloading capabilities, compared to currently available equipment and processes. A solution to these problems would have widespread applicability in industrial processes.

### SUMMARY OF THE INVENTION

The present invention addresses the aforementioned needs in the art, as will now be summarized and then further described in detail below.

Some variations of the invention provide a method of increasing bioavailability of animal feed, the method comprising:
(a) providing a starting animal feed material comprising an animal feed;
(b) hydrating the starting animal feed material with water to provide a hydrated animal feed material containing from about 50 wt % to about 99.99 wt % H₂O;
(c) in a processing chamber (preferably, a continuous-flow processing chamber), treating the hydrated animal feed material at a processing temperature selected from about 40° C. to about 90° C., a processing pressure selected from about-5 psig to about-14 psig, and a processing residence time selected from about 1 minute to about 60 minutes, thereby generating a processed animal feed material; and
(d) recovering the processed animal feed material as an enhanced-bioavailability animal feed, wherein the enhanced-bioavailability animal feed has higher bioavailability compared to the starting animal feed material.

In preferred embodiments, the method is continuous or semi-continuous.

In less-preferred embodiments, the method is conducted in batch or semi-batch.

In some embodiments, the starting animal feed material is selected from the group consisting of oat hulls, oat hay, oat silage, oat straw, oat grain, oats groats, oat meal feed, oat mill byproduct, grasses, and combinations thereof. The starting animal feed material typically includes a primary feed material (e.g., oat hulls) with one or more secondary materials present, such as inerts, additives, etc.

In some embodiments, the starting animal feed material is selected from the group consisting of corn distiller's dried grains with solubles, corn gluten feed, corn gluten meal, corn grain, corn fiber, corn stover, corn fodder, corn whole plants, corn silage, corn cobs, corn bran, and combinations thereof.

In some embodiments, the hydrated animal feed material contains from about 60 wt % to about 90 wt % H₂O. In certain embodiments, the hydrated animal feed material contains from about 70 wt % to about 80 wt % H₂O.

In some embodiments, the processing temperature is selected from about 50° C. to about 85° C. In certain embodiments, the processing temperature is selected from about 55° C. to about 75° C.

In some embodiments, the processing pressure is selected from about −7 psig to about-12 psig. In certain embodiments, the processing pressure is selected from about-8 psig to about-11 psig.

In some embodiments, the processing residence time is selected from about 3 minutes to about 30 minutes. In certain embodiments, the processing residence time is selected from about 5 minutes to about 15 minutes.

The method may further comprise introducing a process additive to the hydrated animal feed material, to the processed animal feed material, and/or to the enhanced-bioavailability animal feed. The process additive may be selected from acids, bases, salts, buffers, solvents, enzymes, microorganisms, or a combination thereof, for example.

In some embodiments, the enhanced-bioavailability animal feed has at least 10% higher bioavailability compared to the starting animal feed material. In certain embodiments, the enhanced-bioavailability animal feed has at least 25% or at least 50% higher bioavailability compared to the starting animal feed material.

In some embodiments, the enhanced-bioavailability animal feed has at least 10% higher usable energy content compared to the starting animal feed material. In certain embodiments, the enhanced-bioavailability animal feed has at least 25% or at least 50% higher usable energy content compared to the starting animal feed material.

In some embodiments, the method further comprising feeding the enhanced-bioavailability animal feed to an animal selected from cows, buffalos, sheep, goats, camels, deer, or any other suitable livestock.

Other variations of the invention provide a system for increasing bioavailability of animal feed, the system comprising a processing chamber configured for continuously or semi-continuously treating a starting animal feed material in the presence of water, at a processing temperature selected from about 40° C. to about 90° C., a processing pressure selected from about-5 psig to about-14 psig, and a processing residence time selected from about 1 minute to about 60 minutes,
wherein the processing chamber has an inlet for receiving premixed water and the starting animal feed material,
wherein the processing chamber has an outlet for recovering a processed animal feed material,
and wherein the processing chamber is configured with (i) gates for allowing inputs and outputs on a continuous basis while maintaining pressure and (ii) a closure surface that cooperates with the closure mechanisms to seal the processing chamber.

In some embodiments, the system is configured with controlled openings that allow a vacuum to be drawn on the system on a continuous basis.

In some embodiments, the system is configured for reuse of condensed vapors to become a portion of the water and animal feed blend in the premixture of the two at a specific percentage based on the type of animal feed.

Other variations provide an enhanced-bioavailability animal feed product produced by a process comprising:
(a) providing a starting animal feed material comprising an animal feed;
(b) hydrating the starting animal feed material with water to provide a hydrated animal feed material containing from about 50 wt % to about 99.99 wt % H₂O;
(c) in a processing chamber, treating the hydrated animal feed material at a processing temperature selected from about 40° C. to about 90° C., a processing pressure selected from about-5 psig to about-14 psig, and a processing residence time selected from about 1 minute to about 60 minutes, thereby generating a processed animal feed material; and
(d) recovering the processed animal feed material as an enhanced-bioavailability animal feed, wherein the enhanced-bioavailability animal feed has higher bioavailability compared to the starting animal feed material.

### BRIEF DESCRIPTION OF THE FIGURES

FIG. 1 depicts an exemplary system for increasing bioavailability of animal feed using continuous or semi-continuous processing.

FIG. 2 depicts an exemplary system for increasing bioavailability of animal feed using continuous or semi-continuous processing (cutaway view of the reaction agitation chamber shows the reaction chamber conveyance auger).

### DETAILED DESCRIPTION OF EMBODIMENTS OF THE INVENTION

The methods, systems, and compositions of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

Some variations of the present invention are predicated on the enhancement of bioavailability accomplished by a series of sequential steps enabling improvement to the feedstock's usable energy content. Using the disclosed technology, a feed material undergoes a 5-100% increase of usable energy content. Using the disclosed technology, some waste products become viable food for an animal. The disclosed technology offers ease of use as well as low costs of equipment and energy input.

Some variations of the invention provide a method of increasing bioavailability of animal feed, the method comprising:
(a) providing a starting animal feed material comprising an animal feed;
(b) hydrating the starting animal feed material with water to provide a hydrated animal feed material containing from about 50 wt % to about 99.99 wt % H₂O;
(c) in a processing chamber (which is preferably continuous), treating the hydrated animal feed material at a processing temperature selected from about 40° C. to about 90° C., a processing pressure selected from about-5 psig to about-14 psig, and a processing residence time selected from about 1 minute to about 60 minutes, thereby generating a processed animal feed material; and
(d) recovering the processed animal feed material as an enhanced-bioavailability animal feed, wherein the enhanced-bioavailability animal feed has higher bioavailability compared to the starting animal feed material.

In preferred embodiments, the method is continuous or semi-continuous. In this specification, “continuous” means that the flow of the animal feed material is continuous for the entirety of the processing. In this specification, “semi-continuous” means that the flow of the animal feed material is continuous for at least a portion of the processing.

In some embodiments, the method is conducted in batch or semi-batch. In this specification, “batch” means that both the animal feed material and the water are processed in batch for the entire treatment. In this specification, “semi-batch” means that the animal feed material is processed in batch while water is added, or removed, during batch processing.

In some embodiments, the starting animal feed material is selected from the group consisting of oat hulls, oat hay, oat silage, oat straw, oat grain, oats groats, oat meal feed, oat mill byproduct, grasses, and combinations thereof. The starting animal feed material typically includes a primary feed material (e.g., oat hulls) with one or more secondary materials present, such as inerts, additives, etc.

In some embodiments, the starting animal feed material is selected from the group consisting of corn distiller's dried grains with solubles, corn gluten feed, corn gluten meal, corn grain, corn fiber, corn stover, corn fodder, corn whole plants, corn silage, corn cobs, corn bran, and combinations thereof.

In some embodiments, the hydrated animal feed material contains from about 60 wt % to about 90 wt % H₂O. In certain embodiments, the hydrated animal feed material contains from about 70 wt % to about 80 wt % H₂O. In various embodiments, the hydrated animal feed material contains about, at least about, or at most about 50, 55, 60, 65, 70, 75, 80, 85, 90, 95, or 99 wt % H₂O, including any intervening range. In certain embodiments, hydration is used until the point at which more hydration would cause free water to be present—that is, to the point of biomass water saturation, at 25° C. or at the processing temperature.

In some embodiments, the processing temperature is selected from about 50° C. to about 85° C. In certain embodiments, the processing temperature is selected from about 55° C. to about 75° C. In various embodiments, the processing temperature is about, at least about, or at most about 40° C., 45° C., 50° C., 55° C., 60° C., 65° C., 70° C., 75° C., 80° C., 85° C., or 90° C., including any intervening range (e.g., 50-75° C.), or any intervening subrange in 1-degree increments (e.g., 60-71° C., which is 140-160° F.).

In some embodiments, the processing pressure is selected from about −7 psig to about −12 psig. In certain embodiments, the processing pressure is selected from about −8 psig to about −11 psig. In various embodiments, the processing pressure is about, at least about, or at most about −1 psig, −2 psig, −3 psig, −4 psig, −5 psig, −6 psig, −7 psig, −8 psig, −9 psig, −10 psig, −11 psig, −12 psig, −13 psig, −14 psig, including any intervening range. The unit “psig” is pounds per square inch gauge pressure; 0 psig=14.7 psi (absolute pressure at sea level)=1.0135 bar. Thus, for example, at sea level, −10 psig=4.7 psi=0.324 bar. Of course, the present invention is not limited to being carried out at sea level.

In some embodiments, the processing residence time is selected from about 3 minutes to about 30 minutes. In certain embodiments, the processing residence time is selected from about 5 minutes to about 15 minutes. In various embodiments, the processing residence time is about, at least about, or at most about 1, 2, 3, 4, 5, 6, 7, 8, 9, 10, 11, 12, 13, 14, 15, 20, 25, 30, 35, 40, 45, 50, 55, or 60 minutes, including any intervening range. It is possible to use processing residence times longer than 1 hour, but this reduces throughput of the system.

The treatment of the animal feed material to enhance bioavailability may be referred to as a thermomechanical process. Without being limited by theory or speculation, it is believed that there is an interplay of both thermal forces and mechanical forces during treatment. Moisture present in the animal feed material, at suitable temperature (above ambient temperature) and pressure (below ambient pressure, i.e. under vacuum) is converted to water vapor, which is technically steam but is below the ordinary boiling point of water (100° C. at 1 bar). Water molecules, while penetrating out of the fiber, are believed to cause rupture of the cell walls of the fiber contained in the animal feed material. This vacuum-assisted rupture leads to a higher bioavailability of the material, which in turn may be caused by particle-size reduction, surface-area increase, depolymerization of sugar polymers, mass-transport increase, surface-tension decrease, other mechanisms, or a combination thereof.

The method may further comprise introducing a process additive to the hydrated animal feed material, to the processed animal feed material, and/or to the enhanced-bioavailability animal feed. A process additive may be used to adjust pH, density, viscosity, extractability, or solubility, for example. The process additive may be selected from acids (e.g., sulfuric acid), bases (e.g., sodium hydroxide), salts (e.g., potassium acetate), buffers (e.g., acetic acid/sodium acetate), solvents (other than the water), enzymes, microorganisms, or a combination thereof, for example. A solvent, when used, may selected from the group consisting of carbon dioxide, alkanes, alkenes, alcohols, and combinations thereof, for example. Enzymes, such as cellulases and xylanases, may be added to hydrolyze sugar polymers, such as cellulose and hemicellulose, into sugar monomers or oligomers. Microorganisms which express these or other enzymes may be added.

As stated earlier, the processed animal feed material, recovered in step (d), has a higher bioavailability compared to the starting material. Bioavailability can be measured according to neutral detergent fiber digestibility (“NDFD”). NDFD is a tool to help benchmark the digestibility of an animal feed. It is also referred to as cell-wall digestibility. In vitro analysis, via wet chemistry, is the preferred method for measuring NDFD. The sample is dried, ground, and incubated in rumen fluid for a period of time, such as 12, 24, or 30 hours. Buffers and minerals are added along with rumen fluid extracted from a cow fit with a ruminal cannula. The animal feed and rumen fluid are incubated in a water bath in an anaerobic environment (carbon dioxide) at a cow's body temperature (about 39° C.) for 48 hours. The flask containing the animal feed sample and rumen fluid is removed from the water bath and the remaining solution is refluxed in NDF solution (commercially available) for 1 hour. After refluxing in NDF solution for 1 hr, the remaining solution is filtered and the NDF that resisted digestion by rumen bacteria is retained on the filter. The digested fraction of the animal feed is the difference between the initial and final neutral detergent fiber remaining in the sample after the rumen-fluid incubation. NDFD is unitless and is usually reported as a percentage (%). The time period used is indicated in the parameter; for example, when using 12 hours, the digestibility is reported as NDFD12, NDFD12 hr, NDFD12 hr %, or the like. In situ measurement of NDFD is also possible. With the in situ method, forages are placed in small bags and then inserted into the rumen of a cow through a ruminal cannula.

In some embodiments, the enhanced-bioavailability animal feed has at least 10% higher bioavailability compared to the starting animal feed material. In certain embodiments, the enhanced-bioavailability animal feed has at least 25% or at least 50% higher bioavailability compared to the starting animal feed material. In various embodiments, the enhanced-bioavailability animal feed has at least 5%, 10%, 15%, 20%, 25%, 30%, 35%, 40%, 50%, 60%, 70%, 80%, 90%, or 100% higher bioavailability compared to the starting animal feed material.

The present invention can be applied for rumen-based animals, such as cows (dairy cows especially, but also beef cows). Lactating dairy cows will eat more dry matter and produce more milk when fed forages that have higher NDFD. NDFD becomes more critical as more forage is fed. Early lactation cows cannot meet their daily energy requirements, so animal feeds with high NDFD encourages higher dry matter intake (DMI), minimizing body weight loss and the excessive need for supplemental grains and fats. High-NDFD forages provide more calories and allow cows to consume more fiber from forage. Diets that are high in NDFD are typically more economical than other options.

The processed animal feed material typically also has higher usable energy content compared to the starting material. There is a strong correlation between bioavailability and usable energy content, although they are distinct parameters.

In some embodiments, the enhanced-bioavailability animal feed has at least 10% higher usable energy content compared to the starting animal feed material. In certain embodiments, the enhanced-bioavailability animal feed has at least 25% or at least 50% higher usable energy content compared to the starting animal feed material. In various embodiments, the enhanced-bioavailability animal feed has at least 5%, 10%, 15%, 20%, 25%, 30%, 35%, 40%, 50%, 60%, 70%, 80%, 90%, or 100% higher usable energy content compared to the starting animal feed material.

Without being limited by theory, it is believed that the present invention enables an increase in the available concentration of sugar oligomers and other organic materials, all of which contain usable energy, in the enhanced-bioavailability animal feed. The available concentration is believed to be increased by one or more mechanisms, such as depolymerization of sugar polymers (e.g., cellulose→cellobiose, other cellulose oligomers, and potentially glucose). Another potential mechanism is increase in mass transport of sugars and other organics out of a bulk phase of the animal feed, and onto a surface where it is physically available for digestion. Another potential mechanism is increase in mass transport of sugars and other organics out of a first bulk phase of the animal feed, and into a second bulk phase, in which the sugars and other organics are more susceptible to digestion by the animal when fed the processed animal feed material.

The mechanisms to enhance bioavailability and usable energy content may also enhance the usable nutrient content of the processed animal feed material. Here, “nutrient” content refers to concentration of minerals, vitamins, cofactors, and the like, which are needed by the animal not directly for calorific value (energy) but for other biological reasons—e.g., catalyzing digestion reactions, bone development, immune function, muscle contractions, or nervous system function. There may be an increase in mass transport of nutrients out of a bulk phase of the animal feed, and onto a surface where it is physically available for consumption by the animal. There may be an increase in mass transport of nutrients out of a first bulk phase of the animal feed, and into a second bulk phase, in which the sugars and other organics are more susceptible to digestion by the animal when fed the processed animal feed material

In some embodiments, the enhanced-bioavailability animal feed has at least 10% higher usable nutrient content compared to the starting animal feed material. In certain embodiments, the enhanced-bioavailability animal feed has at least 25% or at least 50% higher usable nutrient content compared to the starting animal feed material. In various embodiments, the enhanced-bioavailability animal feed has at least 5%, 10%, 15%, 20%, 25%, 30%, 35%, 40%, 50%, 60%, 70%, 80%, 90%, or 100% higher usable nutrient content compared to the starting animal feed material.

In some embodiments, the method further comprising feeding the enhanced-bioavailability animal feed to an animal selected from cows, buffalos, sheep, goats, camels, deer, or any other suitable livestock. For example, the enhanced-bioavailability animal feed may be prepared according to the disclosed technology, and then used on-site for feeding to an animal and/or shipped to another party for feeding to an animal. The enhanced-bioavailability animal feed may be used by another party (e.g., a customer) for something other than feeding to an animal, if there is some beneficial application of the enhanced-bioavailability animal feed.

While some examples of starting animal feed materials are discussed above, a more comprehensive list of possible starting animal feed materials is as follows:
Alfalfa cubes
Alfalfa dehydrated
Alfalfa fresh
Alfalfa hay early bloom
Alfalfa hay midbloom
Alfalfa hay full bloom
Alfalfa hay mature
Alfalfa silage
Alfalfa silage wilted
Barley silage
Barley silage mature
Barley straw
Barley grain
Barley feed pearl byproduct
Barley grain screenings
Beans navy cull
Beet pulp wet
Beet pulp dried
Beet pulp wet with molasses
Beet pulp dried with molasses
Beet tops
Beet top silage
Bluestem fresh mature
Brewers grains wet
Brewers dried grain
Brewers yeast dried
Brome grass fresh immature
Brome grass hay
Canarygrass hay
Carrot pulp
Carrot root fresh
Carrot tops
Cheatgrass fresh immature
Clover ladino fresh
Clover ladino hay
Clover red fresh
Clover red hay
Coffee grounds
Corn whole plant pelleted
Corn fodder
Corn stover
Corn silage milk stage
Corn silage mature well eared
Corn grain dent yellow
Corn grain hi-lysine
Corn and cob meal
Corn cobs
Corn bran
Corn gluten feed
Corn gluten meal
Distillers grain barley
Distillers grain corn
Distillers grain corn with solubles
Distillers silage corn
Distillers dried solubles
Feathermeal hydrolyzed
Grain screenings
Grain dust
Grape pomace stemless
Grass silage
Hominy feed
Hop leaves
Hop vine silage
Hops spent
Linseed meal solvent
Meadow hay
Milo grain
Mint slug silage
Molasses beet
Molasses cane
Molasses cane dried
Molasses citrus
Molasses wood
Oat hay
Oat silage
Oat straw
Oats grain
Oats groats
Oat meal feeding
Oat mill byproduct
Oat hulls
Orange pulp dried
Orchardgrass fresh
Orchardgrass hay
Pea vine hay
Pea vine silage
Pea straw
Peas cull
Peanut hulls
Peanut meal
Peanut skins
Potato vine silage
Potatoes cull
Potato waste wet
Potato waste dried
Potato waste wet with lime
Potato waste filter cake
Poultry litter dried
Poultry manure dried
Prairie hay
Rapemeal
Rye straw
Rye grain
Safflower meal solubles
Safflower meal dehulled solubles
Sagebrush fresh
Sorghum stover
Sorghum silage
Soybean hulls
Soybean hay
Soybean straw
Soybeans whole
Soybean meal
Sudangrass fresh
Sudangrass hay
Sudangrass silage
Sunflower meal
Sunflower meal with hulls
Sunflower hulls
Timothy fresh pre-bloom
Timothy hay early bloom
Timothy hay full bloom
Timothy silage
Tomato pomace dried
Triticale silage
Triticale
Wheat fresh pasture
Wheat silage
Wheat straw
Wheat grain
Wheat grain hard
Wheat grain soft
Wheat bran
Wheat middlings
Wheat mill run
Wheat shorts
Wheatgrass crested fresh early bloom
Wheatgrass crested fresh full bloom
Wheatgrass crested hay
Wheat dried

Other variations of the invention provide a system for increasing bioavailability of animal feed, the system comprising a processing chamber configured for continuously or semi-continuously treating a starting animal feed material in the presence of water, at a processing temperature selected from about 40° C. to about 90° C., a processing pressure selected from about −5 psig to about −14 psig, and a processing residence time selected from about 1 minute to about 60 minutes,
wherein the processing chamber has an inlet for receiving premixed water and the starting animal feed material,
wherein the processing chamber has an outlet for recovering a processed animal feed material,
and wherein the processing chamber is configured with (i) gates for allowing inputs and outputs on a continuous basis while maintaining pressure (vacuum) and (ii) a closure surface that cooperates with the closure mechanisms to seal the processing chamber.

The processing chamber is preferably configured with a conveyance auger or screw. The conveyance auger or screw is not for high-pressure compression, such as in a traditional extruder or expeller. Instead, the conveyance auger or screw is designed for continuously conveying material through the processing chamber. Generally, mechanical elements for conveyance include, but are not limited to, single screws, twin screws, rotors, gears, rams, and reciprocating chamber walls.

In some embodiments, the system is configured with controlled openings that allow a vacuum to be drawn on the system on a continuous basis. For example, the system may be designed for continuous flow by means of airlocks through a processing chamber.

In some embodiments, the system is configured for reuse of condensed vapors to become a portion of the water and animal feed blend in the premixture of the two at a specific percentage based on the type of animal feed.

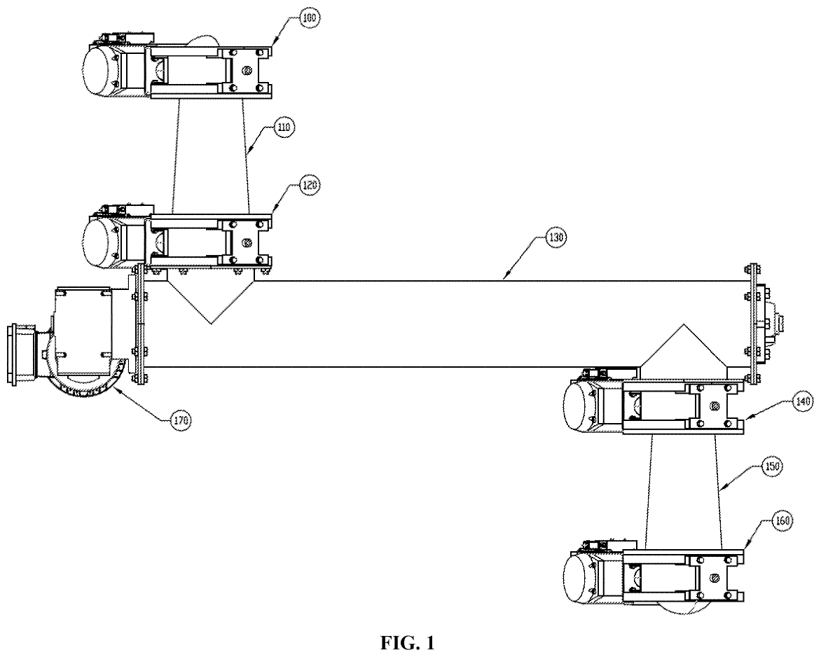

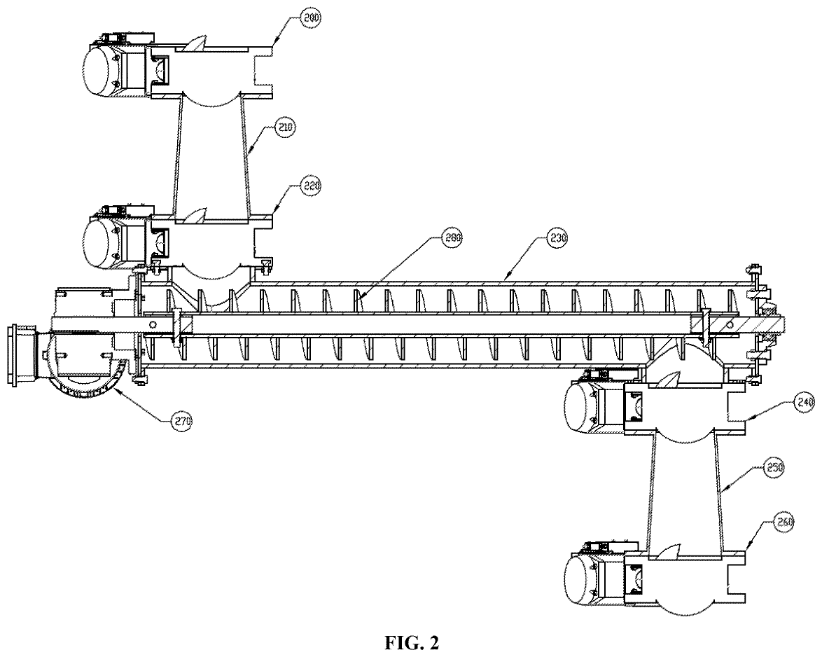

Some embodiments can be understood in reference to FIG. 1, which is an exemplary system for increasing bioavailability of animal feed using continuous or semi-continuous processing. The system includes a reaction agitation chamber 130 which is configured to continuously or semi-continuously treat an animal feed in the presence of water, under vacuum, and at a suitable temperature higher than ambient temperature. At the inlet side of the system, there is an infeed exterior airlock 100, and infeed interior airlock 120, and an infeed depressurization chamber 110 interposed between the infeed exterior airlock 100 and the infeed interior airlock 120. At the outlet side of the system, there is an outfeed interior airlock 140, an outfeed exterior airlock 160, and an outfeed equalization chamber 150 interposed between the outfeed interior airlock 140 and the outfeed exterior airlock 160. A reaction chamber conveyance motor 170 drives a reaction chamber conveyance auger (auger not shown in FIG. 1, but shown in FIG. 2). The infeed interior airlock 120, the infeed depressurization chamber 110, the infeed exterior airlock 100, the outfeed interior airlock 140, the outfeed equalization chamber 150, and the outfeed exterior airlock 160 are configured to maintain vacuum within the reaction agitation chamber 130.

Some embodiments can be understood in reference to FIG. 2, which is an exemplary system for increasing bioavailability of animal feed using continuous or semi-continuous processing. The system includes a reaction agitation chamber 230 which is configured to continuously or semi-continuously treat an animal feed in the presence of water, under vacuum, and at a suitable temperature higher than ambient temperature. In FIG. 2, a cutaway view of the reaction agitation chamber 230 is depicted, showing the internal region of the chamber containing a reaction chamber conveyance auger 280. At the inlet side of the system, there is an infeed exterior airlock 200, and infeed interior airlock 220, and an infeed depressurization chamber 210 interposed between the infeed exterior airlock 200 and the infeed interior airlock 220. At the outlet side of the system, there is an outfeed interior airlock 240, an outfeed exterior airlock 260, and an outfeed equalization chamber 250 interposed between the outfeed interior airlock 240 and the outfeed exterior airlock 260. A reaction chamber conveyance motor 270 drives a reaction chamber conveyance auger 280. The infeed interior airlock 220, the infeed depressurization chamber 210, the infeed exterior airlock 200, the outfeed interior airlock 240, the outfeed equalization chamber 250, and the outfeed exterior airlock 260 are configured to maintain vacuum within the reaction agitation chamber 230.

In some systems, the starting animal feed material is selected from the group consisting of oat hulls, oat hay, oat silage, oat straw, oat grain, oats groats, oat meal feed, oat mill byproduct, grasses, and combinations thereof. The starting animal feed material typically includes a primary feed material (e.g., oat hulls) with one or more secondary materials present, such as inerts, additives, etc.

In some systems, the starting animal feed material is selected from the group consisting of corn distiller's dried grains with solubles, corn gluten feed, corn gluten meal, corn grain, corn fiber, corn stover, corn fodder, corn whole plants, corn silage, corn cobs, corn bran, and combinations thereof.

In some systems, the hydrated animal feed material contains from about 60 wt % to about 90 wt % H₂O. In certain embodiments, the hydrated animal feed material contains from about 70 wt % to about 80 wt % H₂O. In various systems, the hydrated animal feed material contains about, at least about, or at most about 50, 55, 60, 65, 70, 75, 80, 85, 90, 95, or 99 wt % H₂O, including any intervening range.

In some systems, the processing temperature is selected from about 50° C. to about 85° C. In certain systems, the processing temperature is selected from about 55° C. to about 75° C. In various systems, the processing temperature is about, at least about, or at most about 40° C., 45° C., 50° C., 55° C., 60° C., 65° C., 70° C., 75° C., 80° C., 85° C., or 90° C., including any intervening range.

In some systems, the processing pressure is selected from about −7 psig to about −12 psig. In certain systems, the processing pressure is selected from about −8 psig to about −11 psig. In various systems, the processing pressure is about, at least about, or at most about −1 psig, −2 psig, −3 psig, −4 psig, −5 psig, −6 psig, −7 psig, −8 psig, −9 psig, −10 psig, −11 psig, −12 psig, −13 psig, −14 psig, including any intervening range.

In some systems, the processing residence time is selected from about 3 minutes to about 30 minutes. In certain systems, the processing residence time is selected from about 5 minutes to about 15 minutes. In various systems, the processing residence time is about, at least about, or at most about 1, 2, 3, 4, 5, 6, 7, 8, 9, 10, 11, 12, 13, 14, 15, 20, 25, 30, 35, 40, 45, 50, 55, or 60 minutes, including any intervening range. It is possible to use processing residence times longer than 1 hour, but this reduces throughput of the system.

The product that may be produced from the system is an enhanced-bioavailability animal feed, which is preferably continuously or semi-continuously recovered from the system. The enhanced-bioavailability animal feed preferably has at least 10% higher usable energy content compared to the starting animal feed material. In various embodiments, the enhanced-bioavailability animal feed has at least 5%, 10%, 15%, 20%, 25%, 30%, 35%, 40%, 50%, 60%, 70%, 80%, 90%, or 100% higher usable energy content compared to the starting animal feed material. The enhanced-bioavailability animal feed preferably has at least 10% higher usable nutrient content compared to the starting animal feed material. In various embodiments, the enhanced-bioavailability animal feed has at least 5%, 10%, 15%, 20%, 25%, 30%, 35%, 40%, 50%, 60%, 70%, 80%, 90%, or 100% higher usable nutrient content compared to the starting animal feed material.

The system may include a control subsystem for adjusting temperature, pressure, and/or residence time within the process chamber. A control subsystem may be configured to vary parameters during treatment, such as over a prescribed protocol, or in response to measured variables. For example, an unintended change in process chamber vacuum level may be compensated by a change in process chamber temperature and/or residence time. As another example, temperature may be maintained constant (isothermal operation) or pressure may be maintained constant (isobaric operation). The control subsystem may utilize well-known control logic principles, such as feedback control and feedforward control. Control logic may incorporate results from previous experiments or production campaigns. One example of a process chamber subsystem is MasterLogic Programmable Logic Controller from Honeywell (Morris Plains, New Jersey, U.S.).

The system designs disclosed herein can be adapted using known chemical-engineering principles to any scale system for production of large, commercial volumes of products.

The selection of the materials of construction for the system will be dependent on the desired properties and should be considered on a case-by-case basis. Someone skilled in the art of material science or metallurgy will be able to select the appropriate materials for the intended use, based on the information provided in this disclosure.

Other variations provide an enhanced-bioavailability animal feed product produced by a process comprising:
(a) providing a starting animal feed material comprising an animal feed;
(b) hydrating the starting animal feed material with water to provide a hydrated animal feed material containing from about 50 wt % to about 99.99 wt % H₂O;
(c) in a processing chamber (preferably, a continuous-flow processing chamber), treating the hydrated animal feed material at a processing temperature selected from about 40° C. to about 90° C., a processing pressure selected from about −5 psig to about −14 psig, and a processing residence time selected from about 1 minute to about 60 minutes, thereby generating a processed animal feed material; and
(d) recovering the processed animal feed material as an enhanced-bioavailability animal feed, wherein the enhanced-bioavailability animal feed has higher bioavailability compared to the starting animal feed material.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

### EXAMPLES

### Example 1A: Increasing Bioavailability of Oat Hulls

An exemplary method starts with oat hulls having 6.9 wt % starting moisture content. The mass of oat hulls was 250 grams (232.7 grams on a dry basis). 215.4 grams water was added to the chamber along with the as-is oat hulls, so that the resulting moisture content was 50 wt % water, accounting for the initial moisture in the oat hulls (total water introduced was 232.7 grams).

The water was added to a batch reaction chamber. The water was heated to a temperature of 160° F. (about 71° C.). Once the water reached its set-point temperature, the oat hulls were added to the reaction chamber. The reaction chamber was closed and a vacuum pump was started, along with a 10-minute timer. Once the desired vacuum level was reached, the reaction chamber was sealed off from the pump, maintaining the desired vacuum level (chamber pressure of −10 psig, −12 psig, or −14 psig in different experiments). At this point, the temperature of the oat hulls is assumed to also be 160° F. (about 71° C.), i.e. in thermal equilibrium with the water in the reaction chamber. The oat hulls were allowed to soak in the water, under vacuum, for the remainder of the 10 minutes, to complete the reaction.

After the 10-minute treatment, the treated oat hulls were recovered and analyzed for moisture content as well as for bioavailability. The experimental results are shown in Table 1A, which compares to a control sample with no treatment. All three experiments resulted in a modest bioavailability enhancement compared to the control sample.

### Example 1B: Increasing Bioavailability of Oat Hulls

An exemplary method starts with oat hulls having 6.9 wt % starting moisture content. The mass of oat hulls was 250 grams (232.7 grams on a dry basis). 215.4 grams water was added to the chamber along with the as-is oat hulls, so that the resulting moisture content was 50 wt % water, accounting for the initial moisture in the oat hulls (total water introduced was 232.7 grams).

The oat hulls and water were added to the reaction agitation chamber 130/230 shown in FIGS. 1 and 2. The temperature of the reaction agitation chamber was 160° F. (about 71° C.). The oat hulls and water were continuously fed to the reaction agitation chamber, via the infeed depressurization chamber 110/210, and continuously withdrawn from the outfeed equalization chamber 150/250. The reaction contents were made to flow continuously using the reaction chamber conveyance motor 170/270. The residence time in the reaction agitation chamber 130/230 was about 10 minutes. The reaction agitation chamber 130/230 was sealed from the environment using the infeed interior airlock 120/220 and the outfeed interior airlock 140/240, maintaining the desired vacuum level (chamber pressure of −10 psig, −12 psig, or −14 psig in different experiments), to complete the reaction.

After the continuous treatment, the treated oat hulls were recovered and analyzed for moisture content as well as for bioavailability. The experimental results are shown in Table 1B, which compares to a control sample with no treatment. All three experiments resulted in at least 10% bioavailability enhancement compared to the control sample. In these example, the bioavailability enhancement is calculated as the NDFD for the sample divided by the NDFD for the control, expressed as a percentage in comparison to 100% (control). For example, for the −14 psig sample, 32.7/28/9=1.13=+13%.

Also, it can be observed that the results from continuous processing (this Example 1B) are superior to the batch results (Example 1A).

TABLE 1A
Summary of Results for Example 1A

| | | | Bioavailability | Bioavailability |
|---|---|---|---|---|
| | Moisture | | (NDFD**) | Enhancement |
| Control* | 7.4 | wt % | 28.9 | — |
| Pressure = −14 psig | 60.4 | wt % | 31.2 | +8% |
| Pressure = −12 psig | 52.2 | wt % | 30.5 | +6% |
| Pressure = −10 psig | 51.3 | wt % | 29.9 | +3% |

*Hulls with no treatment.
**Neutral detergent fiber digestibility at 12 hours, i.e. NDFD12 hr %.

TABLE 1B
Summary of Results for Example 1B

| | | | Bioavailability | Bioavailability |
|---|---|---|---|---|
| | Moisture | | (NDFD**) | Enhancement |
| Control* | 7.4 | wt % | 28.9 | — |
| Pressure = −14 psig | 52.3 | wt % | 32.7 | +13% |
| Pressure = −12 psig | 53.0 | wt % | 33.6 | +16% |
| Pressure = −10 psig | 52.3 | wt % | 38.7 | +34% |

*Hulls with no treatment.
**Neutral detergent fiber digestibility at 12 hours, i.e. NDFD12 hr %.

### Example 2A: Increasing Bioavailability of DDGs

An exemplary method starts with corn dried distillers grains (DDGs) having 9.4 wt % starting moisture content. The mass of DDGs was 250 grams (226.5 grams on a dry basis). 203.0 grams water was added to the chamber along with the as-is DDGs, so that the resulting moisture content was 50 wt % water, accounting for the initial moisture in the DDGs (total water introduced was 226.5 grams).

The water was added to a batch reaction chamber. The water was heated to a temperature of 160° F. (about 71° C.). Once the water reached its set-point temperature, the DDGs were added to the reaction chamber. The reaction chamber was closed and a vacuum pump was started, along with a 10-minute timer. Once the desired vacuum level was reached, the reaction chamber was sealed off from the pump, maintaining the desired vacuum level (chamber pressure of −10 psig, −12 psig, or −14 psig in different experiments). At this point, the temperature of the DDGs is assumed to also be 160° F. (about 71° C.), i.e. in thermal equilibrium with the water in the reaction chamber. The DDGs were allowed to soak in the water, under vacuum, for the remainder of the 10 minutes, to complete the reaction.

After the 10-minute treatment, the treated DDGs were recovered and analyzed for moisture content as well as for bioavailability. The experimental results are shown in Table 2A, which compares to a control sample with no treatment. All three experiments resulted in at least 50% bioavailability enhancement compared to the control sample, with the optimum vacuum level being-12 psig pressure.

### Example 2B: Increasing Bioavailability of DDGs

An exemplary method starts with corn dried distillers grains (DDGs) having 9.4 wt % starting moisture content. The mass of DDGs was 250 grams (226.5 grams on a dry basis). 203.0 grams water was added to the chamber along with the as-is DDGs, so that the resulting moisture content was 50 wt % water, accounting for the initial moisture in the DDGs (total water introduced was 226.5 grams).

The DDGs and water were added to the reaction agitation chamber 130/230 shown in FIGS. 1 and 2. The temperature of the reaction agitation chamber was 160° F. (about 71° C.). The DDGs and water were continuously fed to the reaction agitation chamber, via the infeed depressurization chamber 110/210, and continuously withdrawn from the outfeed equalization chamber 150/250. The reaction contents were made to flow continuously using the reaction chamber conveyance motor 170/270. The residence time in the reaction agitation chamber 130/230 was about 10 minutes. The reaction agitation chamber 130/230 was sealed from the environment using the infeed interior airlock 120/220 and the outfeed interior airlock 140/240, maintaining the desired vacuum level (chamber pressure of −10 psig, −12 psig, or −14 psig in different experiments), to complete the reaction.

After the continuous treatment, the treated DDGs were recovered and analyzed for moisture content as well as for bioavailability. The experimental results are shown in Table 2B, which compares to a control sample with no treatment. All three experiments resulted in at least 75% bioavailability enhancement compared to the control sample, with the optimum vacuum level being-12 psig pressure, just like in the batch experiments (Example 2A).

TABLE 2A
Summary of Results for Example 2A

| | | | Bioavailability | Bioavailability |
|---|---|---|---|---|
| | Moisture | | (NDFD**) | Enhancement |
| Control* | 12.6 | wt % | 34.4 | — |
| Pressure = −14 psig | 53.4 | wt % | 55.1 | +60% |
| Pressure = −12 psig | 52.6 | wt % | 65.1 | +89% |
| Pressure = −10 psig | 53.0 | wt % | 56.9 | +65% |

*DDGs with no treatment.
**Neutral detergent fiber digestibility at 12 hours, i.e. NDFD12 hr %.

TABLE 2B
Summary of Results for Example 2B

| | | | Bioavailability | Bioavailability |
|---|---|---|---|---|
| | Moisture | | (NDFD**) | Enhancement |
| Control* | 12.6 | wt % | 34.4 | — |
| Pressure = −14 psig | 53.4 | wt % | 60.4 | +76% |
| Pressure = −12 psig | 53.0 | wt % | 63.9 | +86% |
| Pressure = −10 psig | 51.6 | wt % | 61.0 | +77% |

*DDGs with no treatment.
**Neutral detergent fiber digestibility at 12 hours, i.e. NDFD12 hr %.

What is claimed is:

1. A method of increasing bioavailability of animal feed, said method comprising:
(a) providing a starting animal feed material comprising an animal feed;
(b) hydrating said starting animal feed material with water to provide a hydrated animal feed material containing from about 50 wt % to about 99.99 wt % H₂O;
(c) in a processing chamber, treating said hydrated animal feed material at a processing temperature selected from about 40° C. to about 90° C., a processing pressure selected from about −5 psig to about −14 psig, and a processing residence time selected from about 1 minute to about 60 minutes, thereby generating a processed animal feed material; and
(d) recovering said processed animal feed material as an enhanced-bioavailability animal feed, wherein said enhanced-bioavailability animal feed has higher bioavailability compared to said starting animal feed material.

2. The method of claim 1, wherein said method is continuous or semi-continuous.

3. The method of claim 1, wherein said starting animal feed material is selected from the group consisting of oat hulls, oat hay, oat silage, oat straw, oat grain, oats groats, oat meal feed, oat mill byproduct, grasses, and combinations thereof.

4. The method of claim 1, wherein said starting animal feed material is selected from the group consisting of corn distiller's dried grains with solubles, corn gluten feed, corn gluten meal, corn grain, corn fiber, corn stover, corn fodder, corn whole plants, corn silage, corn cobs, corn bran, and combinations thereof.

5. The method of claim 1, wherein said hydrated animal feed material contains from about 60 wt % to about 90 wt % H₂O.

6. The method of claim 1, wherein said hydrated animal feed material contains from about 70 wt % to about 80 wt % H₂O.

7. The method of claim 1, wherein said processing temperature is selected from about 50° C. to about 85° C.

8. The method of claim 1, wherein said processing temperature is selected from about 55° C. to about 75° C.

9. The method of claim 1, wherein said processing pressure is selected from about −7 psig to about −12 psig.

10. The method of claim 1, wherein said processing pressure is selected from about −8 psig to about −11 psig.

11. The method of claim 1, wherein said processing residence time is selected from about 3 minutes to about 30 minutes.

12. The method of claim 1, wherein said processing residence time is selected from about 5 minutes to about 15 minutes.

13. The method of claim 1, wherein said method further comprises introducing a process additive to said hydrated animal feed material, to said processed animal feed material, and/or to said enhanced-bioavailability animal feed, and wherein said process additive is selected from acids, bases, salts, buffers, solvents, enzymes, microorganisms, or a combination thereof.

14. The method of claim 1, wherein said enhanced-bioavailability animal feed has at least 10% higher bioavailability compared to said starting animal feed material.

15. The method of claim 1, wherein said enhanced-bioavailability animal feed has at least 25% higher bioavailability compared to said starting animal feed material.

16. The method of claim 1, wherein said enhanced-bioavailability animal feed has at least 10% higher usable energy content compared to said starting animal feed material.

17. The method of claim 1, wherein said enhanced-bioavailability animal feed has at least 25% higher usable energy content compared to said starting animal feed material.

18. The method of claim 1, said method further comprising feeding said enhanced-bioavailability animal feed to an animal selected from cows, buffalos, sheep, goats, camels, or deer.

19. A system for increasing bioavailability of animal feed, said system comprising a processing chamber configured for continuously or semi-continuously treating a starting animal feed material in the presence of water, at a processing temperature selected from about 40° C. to about 90° C., a processing pressure selected from about −5 psig to about −14 psig, and a processing residence time selected from about 1 minute to about 60 minutes,
wherein said processing chamber has an inlet for receiving premixed water and said starting animal feed material,
wherein said processing chamber has an outlet for recovering a processed animal feed material,
and wherein said processing chamber is configured with (i) gates for allowing inputs and outputs on a continuous basis while maintaining pressure and (ii) a closure surface that cooperates with said closure mechanisms to seal said processing chamber.

20. The system of claim 19, wherein said system is configured with controlled openings that allow a vacuum to be drawn on a continuous basis.
